(19) United States
(12) Patent Application Publication
(10) Pub. No.: US 2025/0015620 A1
(43) Pub. Date: Jan. 9, 2025

(54) SYSTEM, APPARATUS, AND METHOD FOR DETERMINING BATTERY STATE OF HEALTH WITH CHARGE AND DISCHARGE CYCLES

(71) Applicants: Adam Gleason, Draper, UT (US); Manti Gleason, Draper, UT (US)

(72) Inventors: Adam Gleason, Draper, UT (US); Manti Gleason, Draper, UT (US)

(21) Appl. No.: 18/766,452

(22) Filed: Jul. 8, 2024

Related U.S. Application Data
(60) Provisional application No. 63/512,585, filed on Jul. 7, 2023.

(51) Int. Cl. H02J 7/00; H01M 10/44

(52) U.S. Cl. CPC H02J 7/005; H01M 10/441; H02J 7/0013; H02J 7/0045; H02J 7/0048; H02J 7/00712

(57) ABSTRACT

Examples of the present disclosure include a method. The method includes receiving a battery in a slot. The battery is removable from the slot to power a device separate from the slot. The method further includes initiating a discharge cycle of the battery while the battery is received by the slot and measuring, during the discharge cycle, discharge battery data for the battery. The method includes determining, based at least in part on the discharge battery data, a state of health of the battery.

### CROSS-REFERENCES TO RELATED APPLICATIONS

This application claims the benefit of U.S. Provisional Patent Application No. 63/512,585 entitled “SYSTEM, APPARATUS, AND METHOD FOR DETERMINING BATTERY STATE OF HEALTH” and filed on Jul. 7, 2023, which is incorporated herein by reference.

### GOVERNMENT RIGHTS

This invention was made with government support under Contract No. FA864922P1066 awarded by the U.S. Air Force. The government has certain rights in the invention.

### FIELD

This invention relates to battery charging and more particularly relates to systems, apparatuses, and methods for determining battery state of health with charge and discharge cycles.

### BACKGROUND

Batteries provide power to devices in numerous industries and applications, including electric aircraft and electric vehicles. Batteries are charged in preparation to power such devices. Battery state of health (“SoH”) is a representation of the level of degradation and remaining capacity in a battery.

### SUMMARY

Examples of the present disclosure include a method. The method includes receiving a battery in a slot. The battery is removable from the slot to power a device separate from the slot. The method further includes initiating a discharge cycle of the battery while the battery is received by the slot and measuring, during the discharge cycle, discharge battery data for the battery. The method includes determining, based at least in part on the discharge battery data, a state of health of the battery.

Examples of the present disclosure include a system. The system includes a slot, a memory, and at least one processor coupled to the memory. The slot is configured to receive a battery. The battery is removable from the slot to power a device. The device is separate from the slot. The at least one processor is configured to initiate a battery discharge cycle to discharge the battery while the battery is received by the slot. The at least one processor is also configured to measure, during the discharge cycle, discharge battery data for the battery and determine, based at least in part on the discharge battery data, a state of health of the battery.

Examples of the present disclosure include an apparatus. The apparatus includes a discharge module configured to initiate a battery discharge cycle while a battery is received by a slot from which the battery is removable to power a device separate from the slot. The apparatus also includes a discharge measurement module configured to measure, during the discharge cycle, discharge battery data for the battery. The apparatus includes a state of health module configured to determine, based at least in part on the discharge battery data, a state of health of the battery. At least a portion of said modules include one or more of hardware circuits, programmable hardware circuits and executable code, the executable code stored on one or more computer readable storage media.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic diagram illustrating a system, according to one or more examples of the present disclosure;

FIG. 2 is a schematic diagram illustrating a system for discharging and/or charging an unintelligent battery, according to one or more examples of the present disclosure;

FIG. 3 is a schematic diagram illustrating a system for discharging a battery into another battery, according to one or more examples of the present disclosure;

FIG. 4 is a schematic diagram illustrating a device powered by a plurality of batteries, according to one or more examples of the present disclosure;

FIG. 5 is a schematic block diagram illustrating an apparatus, according to one or more examples of the present disclosure; and

FIG. 6 is a schematic flow chart diagram illustrating a method for determining a SoH of a battery, according to one or more examples of the present disclosure;

FIG. 7 is a schematic flow chart diagram illustrating a method for charging a battery, according to one or more examples of the present disclosure;

FIG. 8 is a schematic flow chart diagram illustrating a method of charging a battery based on a charging parameter, according to one or more examples of the present disclosure;

FIG. 9 is a schematic flow chart diagram illustrating a method for updating a predicted a life expectancy of a battery, according to one or more examples of the present disclosure;

FIG. 10 is a schematic flow chart diagram illustrating a method of discharging a battery based on a discharge parameter, according to one or more examples of the present disclosure;

FIG. 11 is a graph illustrating an operational discharge curve of a battery, according to one or more examples of the present disclosure;

FIG. 12A is an external view of an enclosure housing a charging apparatus, according to one or more examples of the present disclosure;

FIG. 12B is an internal view of an enclosure housing a charging apparatus, according to one or more examples of the present disclosure; and

FIG. 13 is schematic diagram of a system for fire suppression, according to one or more examples of the present disclosure; and

FIG. 14 is a schematic diagram of an exhaust system, according to one or more examples of the present disclosure.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

Examples of the present disclosure include a method. The method includes receiving a battery in a slot. The battery is removable from the slot to power a device separate from the slot. The method further includes initiating a discharge cycle of the battery while the battery is received by the slot and measuring, during the discharge cycle, discharge battery data for the battery. The method includes determining, based at least in part on the discharge battery data, a state of health of the battery.

In some examples, the method includes directing power to the battery to charge the battery in a charge cycle while the battery is received by the slot and measuring, during the charge cycle, charge battery data for the battery. Determining the state of health of the battery is further based at least in part on the charge battery data.

In some examples, the method includes determining a parameter of a number of additional batteries and selecting, based at least in part on the parameter and the state of health of the battery, a battery of the number of additional batteries to be paired with the battery. The method also includes notifying a user of the selection. In some examples, the parameter includes at least one of: a state of health, a battery age expressed as a quantity of discharge and/or operational cycles, a battery age expressed as a time period, a predicted failure time, a predicted life expectancy, a charge rate, a discharge rate, and/or any combination thereof.

In some examples, the number of additional batteries includes a first number of additional batteries. The selecting is further based at least in part on a state of health of a second number of additional batteries. The second number of additional batteries includes one or more batteries previously grouped with the battery for powering the device.

In some examples, the method includes determining, based at least in part on the state of health of the battery and the parameter of the number of additional batteries, a charging parameter for the battery and initiating a charge cycle to charge the battery according to the charging parameter. In some examples, the charging parameter includes at least one of: a charging rate, a final charge level of the battery at an end of the charge cycle, or a combination thereof.

In some examples, the charging parameter includes a goal final charge level of the battery. The method includes measuring, during the charge cycle, a charge level of the battery and comparing, during the charge cycle, the charge level of the battery to the goal final charge level. The method includes determining, based at least in part on the comparing and during the charge cycle, that the charge level of the battery is greater than or equal to the goal final charge level and terminating the charge cycle in response to the determining.

In some examples, the method includes predicting a life expectancy of the battery based at least in part on the state of health. In some examples, the charge cycle includes a first charge cycle, and the discharge cycle includes a first discharge cycle. The method further includes measuring additional data for the battery during at least one of a second charge cycle and a second discharge cycle and updating the predicted life expectancy of the battery based at least in part on the additional data. In some examples, the life expectancy of the battery is based at least in part on an output of a machine learning algorithm. An input of the machine learning algorithm includes at least one of: a characteristic of the battery, a battery type, an application for the battery, an operational metric of the battery while the battery powers the device, and/or a combination thereof.

In some examples, the method includes receiving a number of operational metrics. The operational metrics include data collected while the battery powers the device. The method includes determining, based at least in part on the number of operational metrics, a goal discharge parameter value for the battery. Discharging the battery in the discharge cycle includes discharging the battery according to the goal discharge parameter value.

In some examples, the number of operational metrics include an operational battery discharge rate, and discharging the battery according to the goal discharge parameter value includes discharging the battery at a rate that is within a threshold of the operational battery discharge rate.

In some examples, the method includes determining, during the discharge cycle, a discharge parameter value based at least in part on the discharge battery data. The method includes comparing during the discharge cycle, the discharge parameter value to the goal discharge parameter value. The method includes determining, based at least in part on the comparing, whether the discharge parameter value is within a threshold deviation from the goal discharge parameter value. The method includes adjusting, during the discharge cycle and in response to determining that the discharge parameter value is not within the threshold deviation from the goal discharge parameter value, a discharge parameter corresponding to the discharge parameter value.

In some examples, the method includes directing, during the discharge cycle, current from the battery into a load. The load includes at least one of an additional battery charged by the directed current, an uninsulated conductor connected to an exhaust element, a device powered by the directed current, or a combination thereof.

In some examples, the charge battery data includes an input current for the battery and output current for the battery.

In some examples, the discharge battery data includes at least one of: a current measurement from the battery, a temperature of the battery, a voltage measurement, or a combination thereof.

In some examples, measuring the discharge battery data includes receiving the discharge battery data from a battery management system of the battery.

Examples of the present disclosure include a system. The system includes a slot, a memory, and at least one processor coupled to the memory. The slot is configured to receive a battery. The battery is removable from the slot to power a device. The device is separate from the slot. The at least one processor is configured to initiate a battery discharge cycle to discharge the battery while the battery is received by the slot. The at least one processor is also configured to measure, during the discharge cycle, discharge battery data for the battery and determine, based at least in part on the discharge battery data, a state of health of the battery.

In some examples, the system includes a plurality of batteries. The system also includes a plurality of slots. The slot includes a slot of the plurality of slots. The battery includes a battery of the plurality of batteries.

Examples of the present disclosure include an apparatus. The apparatus includes a discharge module configured to initiate a battery discharge cycle while a battery is received by a slot from which the battery is removable to power a device separate from the slot. The apparatus also includes a discharge measurement module configured to measure, during the discharge cycle, discharge battery data for the battery. The apparatus includes a state of health module configured to determine, based at least in part on the discharge battery data, a state of health of the battery. At least a portion of said modules include one or more of hardware circuits, programmable hardware circuits and executable code, the executable code stored on one or more computer readable storage media.

Batteries are used to power devices, such as aircraft. In certain applications, determining a state of health (“SoH”) of a battery can be useful and can help to extend battery life. In some instances, more than one battery is used to power a device. Grouping batteries together based on accurate, up-to-date SoH measurements can help to improve performance and maintain battery health. The present disclosure include methods, systems, and apparatuses that can help with optimal battery pairing by, for example, discharging a battery within a charging apparatus that is separate from the device that the battery powers and measuring data during the discharging.

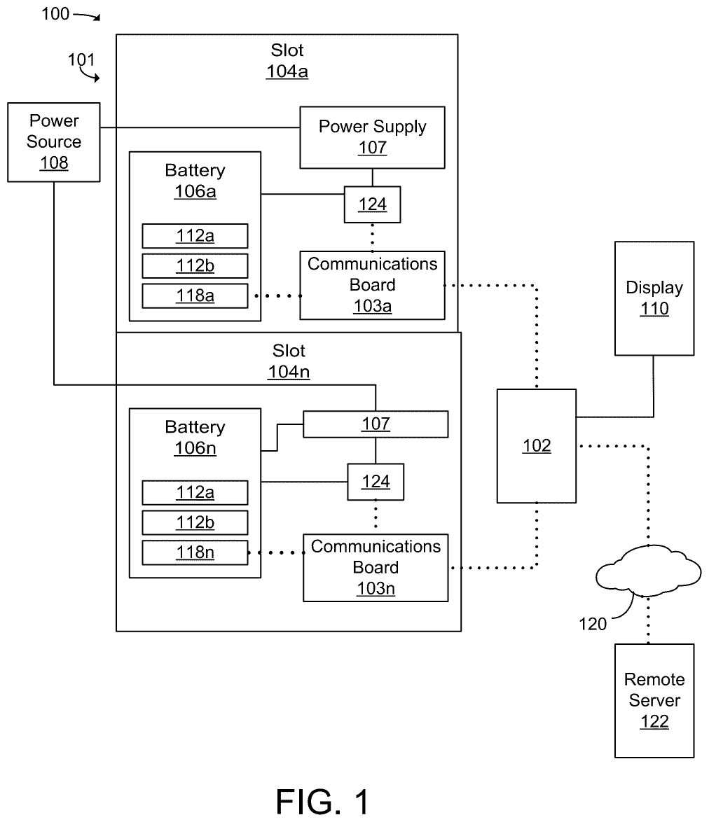

FIG. 1 is a schematic diagram illustrating one embodiment of a system 100 for determining a SoH of a battery 106a, . . . , 106n (which may be referred to herein, individually and/or collectively, as “106”). As shown in FIG. 1, the system 100 includes a number of batteries 106, a number of slots 104a, . . . , 104n (which may be referred to herein, individually or collectively, as “104”), a power source 108, a number of power supplies 107, a number of communications boards 103, a number of switches 124, a local processor 102, a display 110, and a remote server 122 connected to the communications board 103 and/or to the local processor 102 via a network 120.

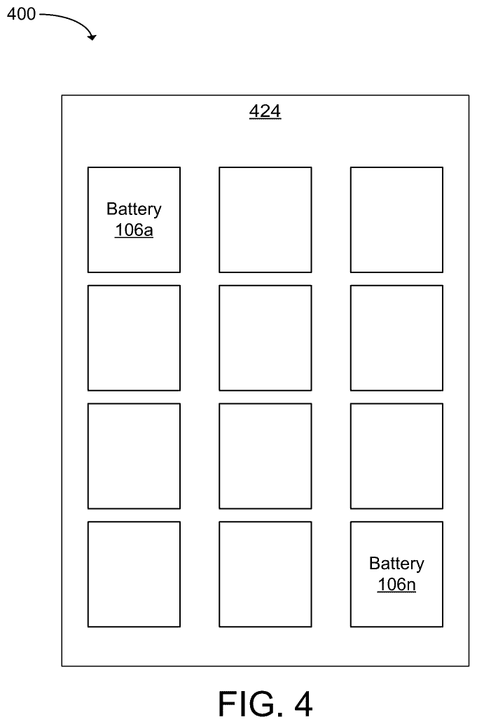

As shown in FIG. 1, the system 100 includes a charging apparatus 101 having a plurality of slots 104. As referred to herein, a “charging apparatus” includes, but is not limited to, the slots 104, communications boards 103, switches 124, power supplies 107, display 110, and/or local processor 102. Each slot 104 is configured to receive at least one of the number of batteries 106. Each of the number of slots 104 is a portion, bay, chamber, and/or slot of the charging apparatus 101. The batteries 106 are rechargeable batteries that are removable from the slots 104 to power a device other than the charging apparatus 101. For example, the batteries 106 are removable from the slots 104 to power the device 424 of FIG. 4.

In some examples, the device 424 includes at least one of the following: a vehicle, an aircraft, an unmanned aerial vehicle (“UAV”) an electric aircraft, a battery energy storage system, and/or any combination thereof. The device 424 is a device 424 that is powered by replaceable batteries 106. In some examples, a first set of batteries 106 powers a device for a first operational cycle, and a different set of batteries 106 powers the device 424 for a subsequent operational cycle. For example, the device 424 is an aircraft, and the device 424 uses a first set of batteries 106 for a first flight and a second set of batteries 106 for a second flight while the first set is being charged by the charging apparatus 101. In some examples, the device 424 is a battery energy storage system, and the batteries 106, as part of the battery energy storage system, are configured to store energy and provide power to the grid (e.g., during period of high demand). In some examples, the batteries 106 are configured to store energy and provide backup power to a particular device and/or to the grid in case of a power supply issue and/or power outage.

The system 100 includes a number of communications boards 103 and a remote server 122. As shown in FIG. 1, in some examples, the communications board 103 communicates indirectly with the remote server 122 via a local processor 102, which is connected to the remote server 122 through the network 120. In other examples, the communications board 103 is communicably connected directly to the remote server 122 via the network 120. In some examples, the system 100 does not include a local processor 102. In some examples, the remote server 122 is configured to perform any of the functions described herein in connection with the local processor 102. In some examples, the local processor 102 is configured to perform any of the functions as described herein in connection with the remote server 122. In various examples, the system 100 includes the local processor 102 but does not include the remote server 122. In such examples, the local processor 102 may or may not be connected to a network 120.

In some examples, the battery 106 includes a battery pack with multiple cells 112a, 112b. Although FIG. 1 shows a battery 106 with only two cells 112a, 112b, examples of the present disclosure are not so limited. For example, batteries 106 include sixteen cells 112 each. In another example, at least one of the batteries 106 includes eight cells 112. In some examples, the batteries 106 are lithium-ion batteries.

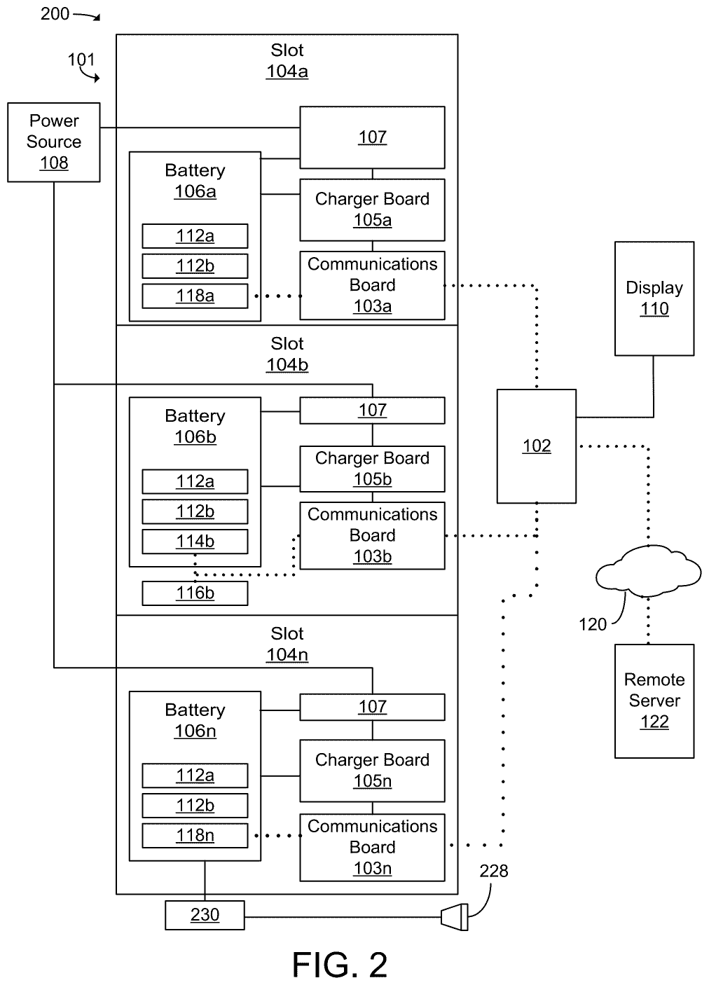

The batteries 106, in some examples, include both intelligent and unintelligent batteries. An intelligent battery 106a includes a battery management system (“BMS”) 118 that is configured to monitor parameters of the battery 106 and/or provide data relating to the battery 106. Referring to FIG. 2, examples of the present disclosure help to measure data from an unintelligent battery 106b during a charge and/or discharge cycle that may otherwise be measured and provided by a BMS 118 of an intelligent battery. In some examples, an unintelligent battery 106b includes an RFID chip 114 that is read by an RFID scanner 116 of a slot 104. For example, the RFID chip 114 stores data including at least one of: a serial number of the battery 106b, previous metrics of the battery 106b, or use of the battery 106b. In some examples, the RFID scanner 116 identifies a battery 106. In various examples, a charger board 105 measures data from the unintelligent battery 106b via wired connections to the unintelligent battery 106b.

While the battery 106 is received by the slot 104, the system 100 is configured to run a charge cycle (directing current into the battery 106 to charge the battery) and/or a discharge cycle (directing current out of the battery to lower the state of charge of the battery 106). The battery 106 remains in the slot 104 for both the charge and discharge cycles. Once the battery 106 is sufficiently charged to be used in the device, the battery 106 is removed from the slot 104 and received by the device 424.

As used herein, the term “charge cycle” refers to a period of time during which a battery is charged to any degree. As such, the term “charge cycle” as used herein is not limited to charging the battery to its full state of charge (“SoC”). The term “discharge cycle” refers to a period of time during which a battery is discharged to any degree. As used herein, the terms “full charge cycle” and “full discharge cycle” may refer to periods of time during which the battery is fully charged or fully discharged, respectively. In some examples, the system 100 determines a SoC that constitutes a full SoC for that battery. For example, a battery has a full SoC of 100%. In another example, another battery that is paired with a battery having a lower capacity is considered “fully charged” at a SoC of 90%.

The system 100 collects data from the battery 106 during the charge and/or the discharge cycles. For example, at least one of the following collects data from the battery: the communications boards 103, BMS 118, sensors within the batteries 106, sensors within the slots 104, and/or wired connections between the charger board 105 and the battery 106. Based on this data, the system 100 determines a SoH of the battery 106. For example, the local processor 102 and/or the remote server 122 determines the SoH of the battery 106. In some examples, the slot 104 receives the same battery 106, the system 100 performs a subsequent charge and/or discharge cycle and updates the SoH of the battery 106. Based on these SoH measurements, the local processor 102 and/or remote server 122 selects an appropriate action to take, such as, but not limited to: pairing the battery 106 with other batteries 106, adjusting charging rates of the battery 106, and/or predicting a life expectancy of the battery 106.

In some examples, each of the slots 104 receives a power supply 107. In other examples, the power supply 107 is located outside of the slot 104 but still connected to the battery 106. Each of the power supplies 107 is powered by a power source 108 and is connected to a battery 106 to supply power to the battery 106 from the power source 108. Referring to FIG. 2, in some examples, the power supply 107 is connected to the battery 106 via a charger board 105. Referring to FIG. 1, in other examples, the power supply 107 is connected to the battery 106 directly and/or indirectly via a switch 124. In some examples, the switch 124 is communicatively coupled to and controllable by at least one of the communications board 103, the local processor 102, and/or the remote server 122.

In some examples, the power source 108 is a generator, such as a generator powered by at least one of: gasoline, solar energy, propane, diesel, and/or natural gas. In some examples, the power source 108 is an additional battery. For example, the power source 108 is a battery into which at least one of the batteries 106 is discharged during a discharge cycle. In such examples, the system 100 is configured to be self-charging. In other examples, the system 100 includes hookups to shore power. For example, the power source 108 is a generator, but the system 100 includes a switch to turn the power source 108 off and a hookup to instead supply shore power to the power supplies 107.

Although not shown in FIG. 1, in some examples, the slot 104 includes a first section that receives the power supply 107 and a second section that receives the battery 106. For example, the slot 104 includes a wall between the first section and the second section, with an opening in the wall through which wires connecting the power supply 107 to the battery 106 are fed.

FIG. 2 illustrates a system 200, according to one or more examples of the present disclosure. In some examples, the system 200 is an example of the system 100. Referring to FIG. 2, in some examples, each slot 104 includes a charger board 105. For example, the charger board 105 is built into the slot 104. The charger board 105 is connected to the power supply 107. The charger board 105 is configured to direct power to the battery 106 within the slot 104 to charge the battery 106 in a charge cycle. In some examples, the charger board 105 includes a circuit and/or a circuit board. In some examples, the charger board 105 is removable from the slot 104. The charger board 105 is exchangeable for a different charger board 105 to accommodate the battery 106. For example, each charger board 105 includes a quantity of inputs and/or switches, and the quantity corresponds to a quantity of cells 112 in the battery 106. In some examples, the charger board 105 is connected directly to the battery 106. In other examples, the battery 106 is electrically connected to a tether circuit board within the slot 104. In some examples, the battery 106 is mechanically connected (e.g., clipped) to the tether circuit board. In some examples, the tether circuit board connects the battery 106 to the charger board 105. In some examples, the charger board 105 is combined with and/or attached to the communications board 103.

In some examples, the charger board 105 is also configured to read data from the battery 106. For example, the charger board 105 reads at least one of the following for a battery 106: serial number, cell voltage, battery voltage, cell resistance, battery resistance, current, battery temperature, or any combination thereof. In some examples, the charger board 105 is configured to detect the presence of a battery 106 within the slot 104 (e.g., by determining that the charger board 105 and/or tether board has been connected to a battery 106) and, in response, transmit a message to the communications board 103. The communications board 103 then transmits the message to at least one of a local processor 102, display 110, and/or remote server 122. In other examples, the communications board 103 is configured to read data directly from the battery 106 without the charger board 105. Referring to FIG. 1, in some examples, the communications board 103 reads data from a BMS 118 of the battery 106. In some examples, the communications board 103 reads data from the battery 106 via one or more wired connections (e.g., cell taps and/or battery terminals) to the battery 106.

In some examples, the battery 106 is an intelligent battery with a battery management system (“BMS”) 118a, . . . , 118n (referred to herein individually or collectively as “118”). The charger board 105 reads data from the BMS 118, and the communications board 103 is configured to receive data from the BMS 118. For example, the communications board 103 receives data directly from the BMS 118 via a wireless connection to the BMS 118.

In some examples, the charger board 105 is configured to connect to an unintelligent battery 106b (i.e., a battery 106b that does not have a BMS 118). The charger board 105b is configured to read data from the battery 106b that would otherwise be supplied by a BMS 118 if the battery 106b were an intelligent battery. The charger board 105 connects to the unintelligent battery 106b and is configured to perform coulomb counting, resistance measurements, and/or current measurements on the unintelligent battery 106b while the unintelligent battery 106b is within the slot 104 during a charge and/or discharge cycle. The charger board 105 then transmits this data to the communications board 103. The communications board 103 can adjust the charge and/or discharge cycle in similar manners as described herein in connection with intelligent batteries.

In various examples, the communications board 103 and charger board 105 also receive information about at least one unintelligent battery via an RFID chip. For example, unintelligent battery 106b includes an RFID chip 114b. In some examples, each slot 104 includes an RFID scanner 116 configured to read identification data wirelessly from the RFID chip 114 of the battery 106. The RFID scanner 116 is in communication with at least one of the communications board 103 and/or the charger board 105. In some examples, charger board 105 and/or communications board 103 are configured to read data from the batteries 106 via a wired connection. In some examples, a wired chip is attached to the battery 106 and connected to the charger board 105 and/or communications board 103. In some examples, the communications board 103 and/or the charger board 105 is configured to measure charge data and/or discharge data based at least in part on measurements from a wired connection to a battery 106 and/or battery cell 112. In some examples, the system 100 includes battery terminals and/or cell taps. For example, the system 100 includes a voltmeter connected to a particular cell tap for a certain cell 112 and configured to measure a voltage reading for that cell 112. The voltage reading can then be transmitted to the communications board 103 and/or the charger board 105. In various examples, the system 100 includes other devices for measuring conditions of the battery, such as a digital temperature sensor.

The communications board 103s are configured to receive instructions and/or read data from at least one of: the charger boards 105, the local processor 102, the RFID scanners 116, the BMSs 118, the remote server 122, other devices connected to the network 120, or any combination thereof. The communications board 103 is also configured to transmit instructions to the charger board 105, the switch 124, and/or the power supply 107. The communications board 103 is configured to transmit data to at least one of the local processor 102, the display 110, the remote server 122, and/or any other device connected to the network 120.

Although FIG. 1 shows the communications board 103 and the charger board 105 separately, examples of the present disclosure are not so limited. In some examples, the communications board and charger board share a circuit board and/or are part of the same circuit. FIG. 1 shows both the communications board 103 and the charger board 105 positioned within the same slot 104. However, examples of the present disclosure are not so limited. In some examples, the communications board 103 and/or charger board 105 are positioned outside of the slot 104 but are still coupled, electrically and/or communicatively, to the battery 106. Additionally, FIG. 1 shows onc communications board 103, one charger board 105, and one battery 106 per slot 104. However, examples of the present disclosure also include charging apparatuses 101 having multiple batteries 106 per slot, with one communications board 103 and one charger board 105 per battery 106.

In some examples, the communications board 103 receives, from a client device, remote server 122, and/or local processor 102, a charging parameter and/or a discharging parameter for the battery 106. For example, the communications board 103 receives at least one of the following for a battery 106 received by a slot 104: a type corresponding to the battery, capacity, efficiency, minimum charge rate, maximum charge rate, operational metrics to be simulated during a discharge cycle, an acceptable deviation of a metric of the battery from an operational metric, an ideal temperature range, past SoH measurements, optimal battery pairings, past battery pairings, and/or any combination thereof.

The communications board 103 transmits, to a client device, remote server 122, and/or local processor 102, at least one of the following for a battery 106 received by a slot 104: serial number, model, charge battery data, discharge battery data, or any combination thereof. In some examples, the communications board 103 also transmits, to a client device, remote server 122, and/or local processor 102 at least one of the following: a temperature of the charger board 105, a temperature within the slot 104, a temperature of the communications board 103, a serial number of the communications board, a ambient conditions (e.g., temperature and/or humidity of an environment) within an enclosure 1202 housing the charging apparatus 101, or any combination thereof.

The communications board 103 is configured to measure charge battery data of a charge cycle. In some examples, measuring charge battery data includes receives charge battery data of a charge cycle. The communications board 103 receives the charge battery data, for example, via a wired or wireless connection to the charger board 105 of the battery slot 104 and/or via a wired or wireless communication connection to a battery management system 118a of a battery 106a. The charge battery data includes, for example, at least one of: an input current of the battery 106, an output current of the battery 106, voltage of battery cells 112, resistance of battery cells 112, battery 106 resistance, battery 106 temperature, a capacity of the battery 106, a SoC of the battery 106, or any combination thereof. In some examples, the resistance measurements of the battery 106 and/or cells 112 include resistance measurements performed while the battery 106 is within the slot 104 but the charge and/or discharge cycle is paused. In some examples, the capacity of the battery 106 includes results of a coulomb counting process performed, for example, by the charging board 105.

In some examples, the communications board 103 also receives the battery serial number from at least one of the charger board 105, RFID scanner 116, BMS 118, or any combination thereof. As such, when the communications board 103 transmits the charge battery data and/or discharge battery data to the local processor 102 and/or remote server 122, that data is tied to a particular identifier for the battery 106.

In some examples, the communications board 103 receives information about the conditions within the slot 104 from the charger board 105. For example, the communications board 103 receives, from the charger board 105, at least one of the charger board's temperature and the charger board's humidity. In some examples, the charger board temperature and charger board humidity represent an ambient temperature and humidity within the slot 104.

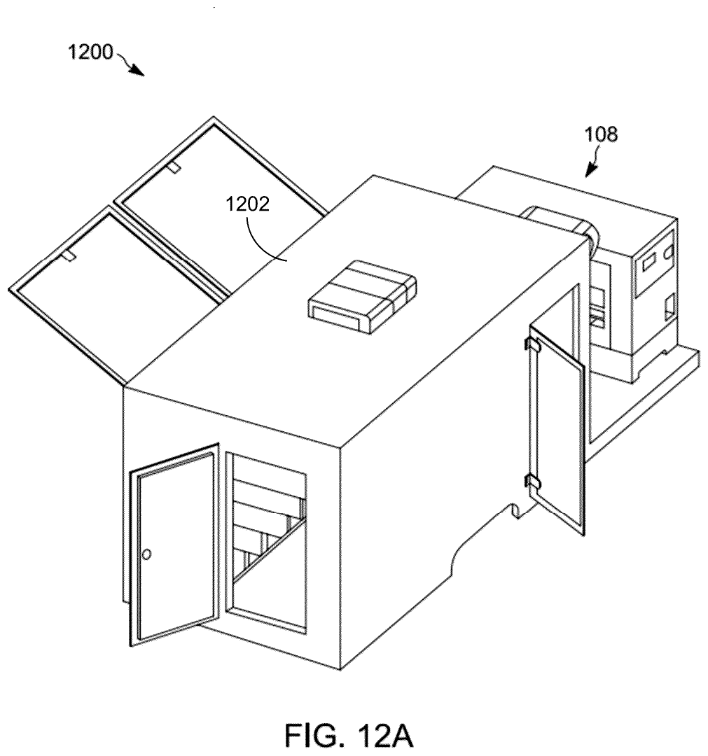

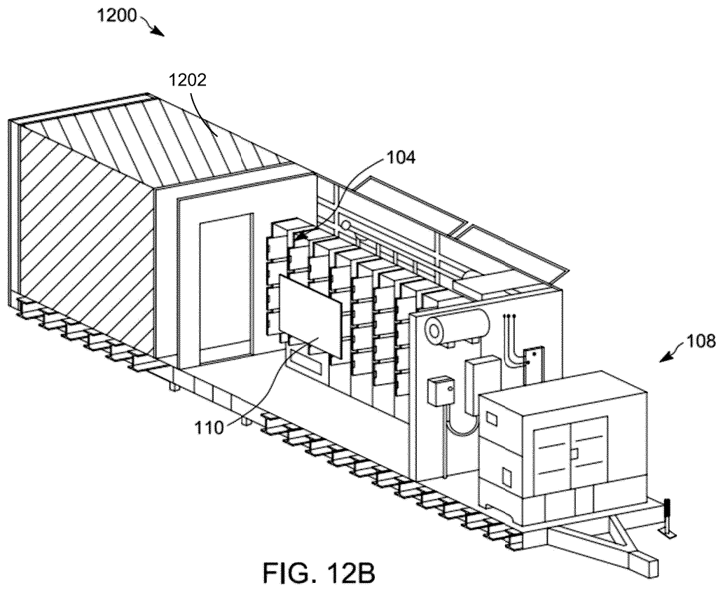

The communications board 103 transmits the charge battery data to a processor. For example, the communications board 103 transmits data to a local processor 102. In some examples, the local processor 102 includes a local server, and the charging apparatus 101, communications board 103, and local processor 102 are all within the same enclosure (e.g., enclosure 1202 shown in FIGS. 12A-B). In some examples, the communications board 103 transmits data to a remote processor, such as to a remote server 122 via a network 120.

The network 120 includes at least one of: an Ethernet connection, the Internet, a local area network, a wide area network, and/or a wireless network. In some examples, the remote server 122 is connected to a number of client devices. The client devices include, for example, computing devices such as mobile communication devices and personal computers. The system 100 also includes applications accessed via the client devices. The functions described herein as being performed by the local processor 102 are, in some additional or alternative examples, performed by another processor communicatively connected to the communications board 103 via the network 120, such as the remote server 122, a client device, and/or any combination thereof. Each of the functions described herein as being performed by the local processor 102 through communication between the local processor 102 and other components of the system 100 may also be performed by the remote server 122 through communication between the remote server 122 and that component of the system 100.

FIG. 1 shows the local processor 102 is connected to a remote server 122 via a network 120. However, in some examples, the local processor 102 is not connected to any network 120 and thus is not connected to the remote server 122. In such embodiments, the local processor 102 is configured to perform the functions described herein as being performed by the remote server 122.

In some examples, the local processor 102 is a processor of a local server. In some examples, the local processor 102 is part of a computing device that is configured to collect and store data for a particular period. For example, the local server is configured to store the data, measurements, and/or calculations herein for a period of thirty-six days. After the period has passed, the memory of the computing device is wiped. In some examples, the computing device transmits the data, measurements, and calculations to another server, such as the remote server 122.

Methods of the present disclosure include receiving a battery 106 into the slot 104. For example, the user inserts the battery 106 into the slot 104 by opening a door of the slot 104. Referring to FIG. 2, in some examples, the slot 104 includes the charger board 105 which connects to the battery 106 through cables and/or pins configured to read data from the battery 106, either directly or through a tether board. When the battery 106 is plugged in to the charger board 105 and/or the tether board, the charger board 105 detects that the battery 106 is present within the slot 104. In some examples, the charger board 105 and/or the communications board 103 activates an RFID scanner 116 of the slot 104 to scan the RFID tag 114 of the battery 106 to identify the battery 106 (e.g., by the battery 106's serial number). In other examples, the communications board 103 and/or the charger board 105 receives a serial number from a BMS 118 of the battery 106. In some examples, the slot 104 includes a sensor (e.g., a motion sensor) through which the system 100 determines that the battery 106 is within the slot 104.

In some examples, the charger board 105 reads the battery 106's serial number from the battery 106. The communications board 103 reads the serial number from the charger board 105 and/or from the BMS 118 and transmits the serial number to the local processor 102. The local processor 102 provides the communications board 103 with charge and/or discharge cycle protocols for that battery. For example, the local processor 102 provides charge and/or discharge cycle protocols based at least in part on at least one of the following: another battery that the battery 106 is paired with, parameters of a future operation planned for the device 424 and/or battery 106, past SoH measurements of the battery 106, charge and/or discharge cycle parameters received from a remote server 122, user input via a GUI of the display 110, a selected charging mode, and/or data from a past operational cycle of the battery 106.

In some examples, the charger board 105 and/or communications board 103 collects initial information about the battery 106 before a charge and/or discharge cycle. For example, the charger board 105 detects that the battery 106 is present and reads at least one of a SoC and/or a temperature of the battery 106. The charger board 105 then transmits this initial battery data to the communications board 103. In some examples, the communications board 103 transmits the initial battery data to the local processor 102.

In some examples, the local processor 102 adjusts at least one of a timing and/or a rate of a charge cycle for the battery 106 based at least in part on the initial battery data. For example, the local processor 102 determines, based on an initial temperature of the battery, that cooling is needed before starting the charge cycle. In response, the communications board 103 delays actuating the power supply 107 to begin a charge cycle until after a delay period has passed between cooling elements activating to cool the battery 106 and the beginning of the charge cycle. In another example, the processor 102 determines, based on battery's 106 temperature read from the slot 104 by the charging board 105, that the temperature of the battery 106 has come within an acceptable charging range. The processor 102 then initiates a charge cycle by instructing the communications board 103 to initiate the charge cycle. In another example, the local processor 102 determines an ideal charge rate for the charge cycle of the battery 106 based at least in part on the initial battery data and transmits that ideal charge rate to the communications board 103.

In some examples, the local processor 102 automatically initiates charge and discharge cycles to determine the SoH of the batteries 106. For example, the local processor 102 initiates a charge cycle, discharge cycle, and another charge cycle periodically such that the batteries 106 are charged to generate battery charge data and in preparation for a discharge cycle, discharged to generate battery discharge data, and charged in preparation for future use in a device 424. The periodicity of a charge and/or discharge cycle can correspond to a particular periodicity of use of the battery 106. In some examples, the periodicity is daily and/or weekly.

In other examples, the local processor 102 initiates a charge cycle and/or a discharge cycle based on input from a user. For example, the local processor 102 receives an instruction from a user to initiate a charge and/or discharge cycle via a graphical user interface of the display 110 and/or a computing device (e.g., a mobile phone or a computer) connected to the processor 102 via the network. In such examples, the processor 102 is configured to request permission from the user to initiate a charge cycle and/or discharge cycle at a certain frequency. For example, if a charge cycle and/or discharge cycle has not been performed on a slot 104 in over twenty-four hours, the processor 102 sends a message to a user requesting permission to perform a charge, discharge, and subsequent charge cycle. If the user confirms, the processor 102 initiates the charge cycle.

The communications board 103 is configured to initiate a charge cycle of the batteries 106 based on input from at least one of the local processor 102 and/or remote server 122. For example, the communications board 103 instructs the charger board 105 to initiate a flow of current from the power supply 107 to the battery 106. In some examples, the communications board 103 also instructs the power supply 107 to initiate a flow of current to the battery 106. In some examples, the communications board 103 instructions the switch 124 to allow current to flow from the power supply 107 to the battery 106. In some examples, the power supply 107, switch 124, and/or charger board 105 initiates the flow of current to the battery 106 at a rate specified by the communications board 103. In some examples, the communications board 103a initiates a charge and/or discharge cycle via communication with a switch 124 controllable to control the flow of current from the power supply 107 to the battery 106.

In various examples, the charger board 105 confirms that the rate of charge is at or below the rate specified by the communications board 103. In response to determining that the rate of current flow is at or below that rate, the charger board 105 allows the current to flow through to the battery 106. If the charger board 105 determines that the rate of current flow from the power supply 107 is above the specified rate, the charger board 105 adjusts the rate of current flow to the battery 106 so as not to exceed the specified rate.

The system 100 collects charge battery data during the charge cycle. In some examples, the BMS 118 transmits the charge battery data to the communications board 103. In some examples, the charger board 105 reads the charge battery data and transmits it to the communications board 103.

The system 100 is configured to run a discharge cycle on the battery 106 while the battery 106 is received within the slot 104 without removing the battery 106 from the slot 104. For example, the local processor 102 initiates a battery discharge cycle by transmitting an instruction to the communications board 103 to initiate a battery discharge cycle. The communications board 103 activates a reverse flow of current out of the battery 106 to initiate the battery discharge cycle. For example, the communications board 103 activates a switch 124 and/or instructs the charger board 105 to activate a switch connected to the power supply 107 to initiate the discharge cycle, directing current out of the battery 106 and into a load (e.g., load 230 of FIG. 2) to discharge the battery 106. The battery 106 remains in the slot 104 during the discharge cycle. In some examples, the battery 106 is discharged according to a preferred discharge metric, such as an operational discharge metric described below (e.g., discharge rate). In some examples, the processor 102 receives the preferred discharge metric and communicates that metric to the communications board 103. In some examples, the processor 102 receives the discharge metric from at least one of a remote server 122, remote computing device, or input via a GUI of the display 110. For example, a user inputs the preferred discharge metric and/or selects a battery care profile including the preferred discharge metric via a dashboard of a web application on a remote computing device.

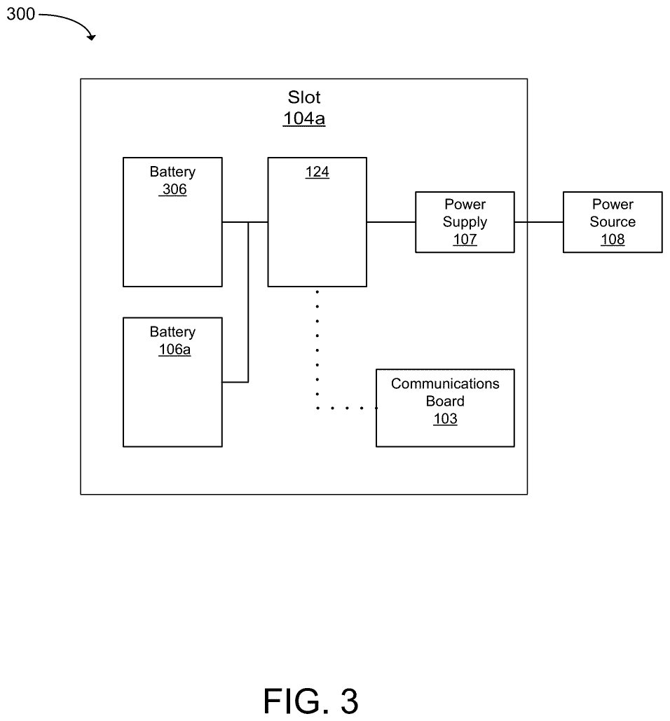

For example, as shown in FIG. 2, the charger board 105n discharges the battery 106n into a load, such as a conductor 230. The conductor 230 then transfers heat into an exhaust element 228. In another example, as shown in FIG. 3, the charger board 105a directs current from the battery 106a being discharged into another battery 306 to charge the other battery 306. In some examples, the conductor 230 is an uninsulated conductor, such as a dryer heating element. In some examples, the conductor 230 is connected to an exhaust element 228. Although FIG. 2 shows the conductor 230 within the slot 104n, examples of the present disclosure are not so limited. In some examples, the conductor 230 is outside of the slots 104 and, for example, below the slots 104. In various examples, a plurality of batteries 106 are connected to the same conductor 230.

FIG. 3 illustrates a system 300 for discharging a battery 106a. In some examples, the system 300 is part of the system 100. In one or more examples, the system 300 is part of the charging apparatus 101. In various examples, the system 300 is a device. As shown in FIG. 3, in some examples, the load is a second battery 306. The second battery 306 is within the same slot 104a as the battery 106a being discharged. As such, while the battery 106a is discharged, the second battery 306 is charged. For example, as shown in FIG. 3, the charger board 105 directs the current into the second battery 306. In some examples, the second battery 306 is located outside of the slot 104a. For example, the second battery 306 is located in a stack of batteries that each of the batteries 106 discharge into as a centralized load.

Although FIG. 3 shows a battery 106a being discharged into an additional battery 306 that is positioned within the slot 104a of the battery 106a, examples of the present disclosure are not so limited. In some examples, the slots 104 are arranged in vertical columns and/or horizontal rows. In such examples, batteries 106 in slots 104 of the same column each discharge into a battery positioned below or above the column. In some examples, the batteries 106 discharge into more than one battery. In some examples, each of the batteries 106 discharge into the same additional battery, and the additional battery serves as the power source 108 for the system 100.

In some examples, the load is an electrically powered device. The electrically powered device includes, for example, an electric motor, a power source for a display 110, and/or any combination thereof.

In some examples, the system 100 is configured to discharge the battery 106 down to a voltage level that is equivalent to a minimum level that is to be expected during operation of the battery 106 in the device 424. For example, the local processor 102 receives data from the device 424 indicating that the battery 106 was discharged down to a 20% SoC during a previous operation cycle. The communications board 103 initiates the discharge cycle for the battery 106 and reads the SoC of the battery 106 while discharging (e.g., from the BMS). In other examples, the charger board 105 transmits the SoC of the battery 106 to the communications board 103 during discharge. In some examples, the communications board 103 determines that the SoC of the battery is equal to, within an acceptable deviation of, or less than 20% and instructs the charger board 105 and/or the switch 124 to stop the discharge cycle. The charger board 105 and/or switch 124 stops the discharge cycle.

The charger board 105 and/or the communications board 103 is configured to measure discharge battery data, or data relating to the battery 106 throughout the discharge cycle. For example, the discharge battery data includes at least one of: resistance of a cell 112, resistance of the battery 106, an output current of the battery, a temperature of the battery, a voltage of a cell 112 of the battery 106, and a battery 106 voltage. In some examples, reading the cell 112 resistance and/or battery 106 resistance involves temporarily pausing the discharge cycle to measure the resistance.

The communications board 103 transmits the discharge battery data and the charge battery data to a processor, such as the local processor 102. The local processor 102 is configured to determine, based at least in part on the charge battery data and/or on the discharge battery data: a SoH of the battery 106, a predicted degradation in SoH of the battery 106, and/or any combination thereof.

In some examples, the local processor 102 is configured to predict a degradation in SoH of the battery 106 for a particular operation. In some examples, the local processor 102 receives operational metrics for the future operation (e.g., ambient temperature, operation length, altitude, etc.) and initiates the one or more discharge cycles with parameters selected to mimic those operational metrics. Examples of the present disclosure include determining a change in SoH of the battery 106 over the discharge cycles and predicting a degradation in the SoH of the battery 106 for a future operation based at least in part on the determined change in SoH. In various examples, the local processor 102 is configured to predict a degradation in the SoH of the battery based at least in part on SoH measurements for that battery 106 over multiple discharge and/or operational cycles. In some examples, methods of the present disclosure include determining a safety rating for the battery 106 based at least in part on the SoH and/or SoH degradation.

In some examples, the local processor 102 is further configured to determine optimal battery pairing based at least in part on SoH. For example, as shown in FIG. 4, in some embodiments, the device 424 is powered by multiple batteries 106. Pairing batteries 106 with other batteries of similar SoH levels can help to optimize performance and life expectancy of the battery 106. As used herein, the term “pairing” refers to grouping any number of batteries 106 and is not limited to grouping exactly two batteries 106. In various examples, the local processor 102 is configured to determine battery 106 pairings based at least in part on an application for that battery 106 (e.g., powering a UAV for long flights, supplying power as part of a battery energy storage system, etc.).

The local processor 102 is configured to determine a SoH of each of a number of additional batteries. For example, the local processor 102 determines a SoH of a battery 106a and of each of a number of additional batteries 106b, . . . , 106n. Although FIG. 4 shows each of the number of additional batteries 106b, . . . , 106n within the device 424, examples of the present disclosure are not so limited. In some examples, the local processor 102 also considers batteries not yet used to power the device 424 in determining optimal pairing. For example, the device 424 is powered by eighteen batteries 106. However, the quantity of batteries in the pool of batteries considered for pairing is greater than eighteen.

For example, the device 424 is powered by eighteen batteries 106 for each flight. The local processor 102 determines which of seventy-two batteries 106 to use for an upcoming flight. For example, the local processor 102 determines which batteries 106 to use based on at least one of: battery requirements for the upcoming flight received from a remote server 122 and/or from the device 424; a most recent SoH for each battery 106; a most recent SoC for each battery 106; or a combination thereof. The system 100 then presents the user with the optimal combination of batteries 106. For example, the system 100 presents the serial numbers and/or indicators of the slots 104 of each battery 106 of a combination of batteries 106 determined to be the best combination for the flight.

The local processor 102 selects, based at least in part on the SoH of the battery 106a and each of the number of additional batteries 106b, . . . , 106n, at least one battery of the number of additional batteries 106b, . . . , 106n to be paired with the battery 106a for powering the device 424. For example, the local processor 102 determines a SoH of the battery 106a and selects at least one other battery and/or multiple additional batteries 106b, . . . , 106n that are of a similar SoH to pair with the battery 106a. In some examples, the selection is also based on the SoH of batteries already paired with the battery 106a for powering the device 424.

In some examples, the local processor 102 determines a pairing of batteries 106 based at least in part on a battery age, which can be expressed as a quantity of discharge and/or operational cycles which the battery 106 has gone through in its lifespan and/or a time period of the battery 106's current lifespan. In various examples, the local processor 102 determines a pairing of batteries 106 based at least in part on a predicted failure time and/or a predicted life expectancy. In such examples, methods of the present disclosure include pairing batteries 106 together that are predicted to fail at similar future times. In some examples, the local processor 102 is configured to determine a battery 106 pairing based at least in part on, a charge rate, a discharge rate, and/or any combination thereof. As such, the local processor 102 can pair batteries 106 together that are more likely to be charged and ready for operation at the same time.

In some examples, the local processor 102 determines that another battery is needed to be paired with a group of batteries. For example, one of the batteries in the group of batteries needs to be replaced. The processor determines the SoH of each battery 106. The local processor 102 determines that a battery 106a has a SoH that is most similar to the SoH of the group of batteries and, based on that determination, selects the battery 106a as the replacement battery. In some examples, the determination is also based at least in part on the SoC of the battery 106. For example, the local processor 102 selects a battery 106 that is fully charged and ready for operation.

In some examples, the local processor 102 is configured to determine a battery pairing for a particular future operation. In some examples, the local processor 102 receives certain operational conditions for the future operation, and the future operation includes powering the device 424. In various examples, the processor 102 determines the battery pairing based at least in part on an output from a machine learning algorithm. In some examples, the inputs for the machine learning algorithm include: characteristics of paired batteries 106 (e.g., age, SoH, etc.), an operational parameter of the paired batteries 106, an application of the paired batteries 106 (e.g., battery energy storage, aircraft, etc.), performance of a pair of batteries 106, SoH degradation, and/or any combination thereof. In some examples, the output includes a selection of one or more batteries 106 to be paired with a battery 106. In some examples, the machine learning algorithm is trained on data from other batteries 106 in the system and/or batteries from other systems. In various examples, the remote server 122 receives the data from other batteries in other systems (e.g., over a network 130), and inputs that data into the machine learning algorithm. In some examples, an input of the machine learning algorithm includes battery type (e.g., lithium-ion battery).

In some examples, the local processor 102 is configured to determine a battery pairing based at least in part on a start time of a future operation. For example, the start time of the future operation is 5:00 a.m., and the local processor 102 determines pairings of batteries 106 that can be ready for operation at that start time based at least in part on: a current SoC of the battery 106, a typical charge rate for the battery 106, and/or any combination thereof.

In some examples, the local processor 102 is configured to predict a start time of a future operation based at least in part on data from past operations. In some examples, the predicted start time is an output of an operation prediction machine learning algorithm. In various examples, the inputs of the operation prediction machine learning algorithm include at least one of: a time of day, a month of the year, a season, an application, a demand for a particular operation, a quantity of batteries used for a past operation, and/or any combination thereof. In some examples, the operation prediction machine learning algorithm is trained on data from past operations using batteries 106 of a particular type. For example, the operation prediction machine learning algorithm is trained on data that demonstrates that a high quantity of lithium-ion batteries are requested for UAV commercial and/or residential deliveries in December. In such examples, methods of the present disclosure include predicting a start time of an operation to include the month of December for a lithium-ion battery 106 of the system 100. In various examples, the remote server 122 receives a data set from a user. The dataset includes historic trends relating to operations (e.g., occurrences of particular operations over time), and the operation prediction machine learning algorithm is trained on that dataset.

In one or more examples, the local processor 102 is configured to pair batteries 106 based at least in part on the predicted start time. In some examples, the local processor 102 is configured to actuate charge and/or discharge cycles based at least in part on the predicted start time.

The local processor 102 is configured to transmit the pairing selection to a user. For example, the local processor 102 transmits an identification of the selected battery 106a to a display 110. In other examples, the local processor 102 transmits the selection to the user via a mobile application of a mobile device connected to the network 120. The selection includes identifying information for the battery 106, such as a serial number.

In some examples, the system 100 adjusts the charging of the battery 106 based at least in part on battery pairings. For example, the local processor 102 is configured to determine an ideal charge rate of the battery 106 based at least in part on the SoH of the battery 106 and the SoH of another battery 106 that the battery 106 is paired with. In such examples, the local processor 102 communicates with the communications board 103 to adjust the charging rate of the battery 106. The communications board 103 communicates with the charger board 105 and/or the switch 124 to adjust the charging rate of the battery 106. In some examples, the charger board 105 is also configured to adjust the charging rate of the battery 106 without communication from the communications board 103 in the event that connection between the charger board 105 and the communications board is lost. In some examples, the charger board 105 has a pre-set safety limit. The charger board 105 is configured not to allow a charging rate greater than the pre-set safety limit, even if the communications board 103 instructs the charger board 105 to charge at such a rate.

In some examples, the switch 124 includes a relay. In some examples, the communications board 103 is a control circuit, and the battery 106 and power supply 107 are connected as part of a controlled circuit. In some examples, the switch 124 provides isolation between the communications board 103 and the controlled circuit. In some examples, the switch 124 includes an electromechanical relay. In other examples, the switch 124 includes a solid-state relay. In some examples, the switch 124 includes a board with multiple switches configured to control flow of current to different batteries 106 and/or battery cells. In some examples, the switch 124 is part of the charger board 105, shown in FIG. 2.

In some examples, adjusting the charging rate of the battery 106 is done on a battery cell 112 basis. For example, the charger board 105 and/or the switch 124 include a switch corresponding to each cell 112a, 112b of the battery 106 and directs current flow to a first battery cell 112a at a different rate than to a second battery cell 112b.

In some examples, the local processor 102 determines a goal charge level of the battery 106. The local processor 102 determines a goal maximum state of charge (“SoC”) to which the battery 106 should be charged before the charge cycle ends. The goal charge level is based at least in part on the SoH of the battery 106 and the SoH of other batteries 106 that the battery 106 is paired with. In some examples, the SoC is expressed as a percentage.

In some examples, the communications board 103 adjusts the maximum SoC for a battery and communicates that maximum SoC to the processor 102 and/or adjusts the goal charge level received by the processor 102 based on the maximum SoC. For example, two 5V batteries 106 are paired together. However, due to declining SoH, one of the batteries 106 can only be charged to a maximum SoC of 4.8V. The communications board 103 determines a new maximum SoC for that battery 106 of 4.8V and transmits that maximum to the processor 102. Additionally or alternatively, the communications board 103 adjusts the goal charge rate received from the local processor 102 based on the new maximum SoC of 4.8V. In some examples, the battery 106 is paired with another battery 106 that is capable of being charged to 5V. However, to preserve SoH of both batteries, the communications board 103 adjusts the maximum SoC of the second battery to 4.8V to match the maximum SoC of the first battery 106.

In some examples, the local processor 102 determines, based on a SoH of the battery 106 and the SoH of other batteries 106 that the battery 106 is paired with, that the goal SoC is 80% charge rather than 100% charge. During a charge cycle, the communications board 103 determines a SoC of a battery 106 based on measured charge data. The communications board 103 transmits the SoC to the local processor 102. In another example, the local processor 102 determines the SoC based on communication with a BMS 118 of the battery. The local processor 102 determines that the SoC is greater than or equal to 80% and terminates the charge cycle. For example, the local processor 102 terminates the charge cycle through communication with the power supply 107 and/or with a switch controlling charge current to the battery 106.

In some examples, the batteries 106 are paired based on regularly updated SoH measurements. For example, three batteries 106 are grouped together for a first flight based on similar SoH measurements amongst the three batteries 106. However, after the first flight, further SoH measurements of the three batteries 106 and additional batteries 106 (e.g., from additional charge and/or discharge cycles) indicate that at least one of the three batteries 106 should be grouped with another group of batteries 106 that are now more similar in SoH levels. In such examples, the battery 106 pairings are updated based on subsequent SoH measurements.

In some examples, the system 100 performs a battery pairing assessment at a frequency requested by a user. For example, the system 100 updates pairings on a weekly basis based on requests from a user. In some examples, the system 100 determines a battery pairing for a first application of the batteries 106. Once the batteries 106 are no longer useful for that application (e.g., the batteries 106 have a predicted life expectancy that is too low to be used to power aircraft), the system 100 determines an updated battery 106 pairing for a second-life application, such as for use as part of a battery energy storage system.

In some examples, the local processor 102 and/or the remote server 122 is further configured to predict a life expectancy of the battery 106 based at least in part on the SoH. The local processor 102 and/or the remote server 122 updates the predicted life expectancy of the battery 106 based on later SoH measurements. For example, the predicted life expectancy of the battery 106 is based on an aggregate of SoH measurements throughout the lifetime of the battery 106. The local processor 102 uses SoH measurements from different charge cycles and/or discharge cycles of the battery 106. As used herein, the “life expectancy” refers to at least one of: a number of charging cycles remaining until the battery 106 is unfit for use, a predicted remaining operation time until the battery 106 is unfit for use, or any combination thereof.

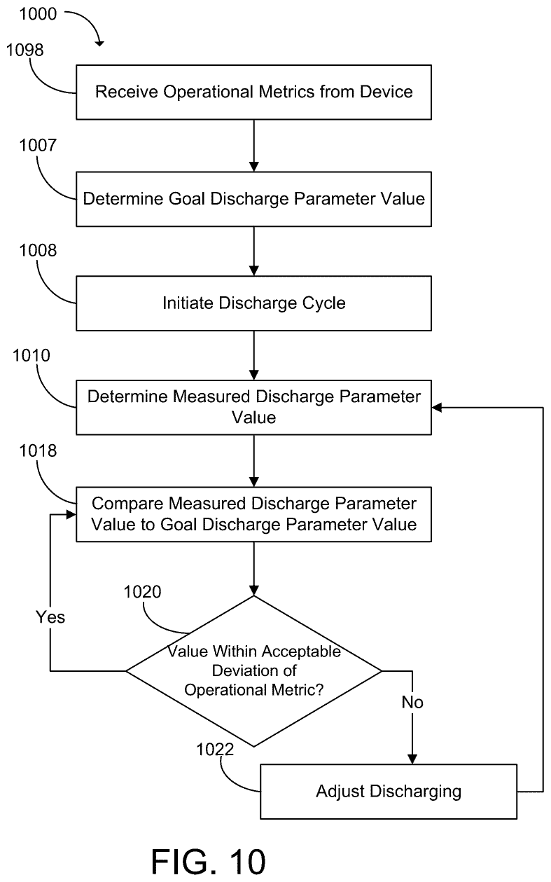

In some examples, the life expectancy is based at least in part on a predicted future SoH. For example, the local processor 102 tracks SoH degradation over time and/or over a number of cycles. In some examples, one “cycle” includes a discharge cycle of the battery 106 powering the device 524 and a charge cycle of the battery 106 within the slot 104. The processor 102 predicts a SoH for the battery for a given number of cycles into the future. In some examples, the prediction is also based on operational metrics. For example, the life expectancy prediction is based on the curve 1002 of FIG. 10 and/or on curves for the same battery 106 powering a device 424.

In some examples, the RFID chip 114 and/or the BMS 118 is configured to store the predicted life expectancy. In other examples, the predicted life expectancy is associated with the serial number of the battery 106. A mobile application stores information related to each battery 106, organized by battery serial numbers. That information includes, for example, the aggregated, lifetime SoH measurement and/or the predicted life expectancy. In some examples, the mobile application scans or receives a serial number of the battery from the user and displays the life expectancy to the user. In other examples, the charging apparatus 101 scans and/or reads the serial number of the battery 106 and displays the predicted life expectancy on the display 110 of the charging apparatus 101.

In some examples, the local processor 102 and/or remote server 122 updates a battery profile based on the predicted life expectancy. The user can access the battery profile, for example, through a mobile application and can view the predicted life expectancy. In some examples, the battery profile is a report that includes at least one of the following: the predicted life expectancy, the most current SoH measurement, past SoH measurements, total time that the battery 106 has been in operation powering the device 424, optimal battery pairings, the quantity of charge cycles the battery 106 has been through, the quantity of discharge cycles the battery 106 has been through, or any combination thereof. In some examples, the battery profile includes information about the charge and discharge cycles that the battery 106 has experienced. This includes, for example, a level of charge and/or discharge (i.e., change in SoC throughout the cycle), charge/discharge rate, total time of storage (e.g., storage within a charging apparatus), or any combination thereof.

In some examples, the system 100 creates conditions for the charge and/or discharge cycle that resemble conditions of use (or “operational metrics”) of the device 424. For example, the local processor 102 receives operational metrics from the device 424. The operational metrics include data collected from the battery 106 while the battery 106 powers the device 424. For example, the operational metrics include at least one of the following for a particular battery 106: total time of discharge in the device 424, SoC over time, initial SoC, final SoC, temperature, cell voltage, battery voltage, input current, output current, and/or any combination thereof. In some examples, a user inputs the operational metrics to the local processor 102 via a GUI and/or input devices connected to the display 110.

For example, the local processor 102 is a processor of a computing device that receives a flash drive with the operational metrics stored thereon. In other examples, the device 424 transmits the operational metrics to at least one of an RFID chip 114 and/or a BMS 118 of the battery 106. The communications board 103 then reads the operational metrics from the BMS 118 and/or the RFID scanner 116. In other examples, the display 110 includes a graphical user interface through which the user inputs the operational metrics. In another example, the remote server 122 receives the operational metrics.

In some examples, the local processor 102 receives the operational metrics from a mobile application and/or a web application of a remote computing device. For example, the local processor 102 receives the operational metrics over a network connection or other wireless connection, such as Bluetooth®.

In some examples, the operational metrics include a battery discharge rate. For example, the operational metrics include a rate at which the battery 106 was discharged during a use of the device 424 and/or will likely be discharged during future use of the device 424.

In some examples, the communications board 103 and/or the charger board 105 cause the battery 106 to discharge at a rate that is within an acceptable deviation of the operational discharge rate. For example, the charger board 105 receives operational metrics, such as the operational discharge rate and acceptable deviation, from the communications board 103. The charger board 105 reads discharge battery data, such as a SoC from the battery 106, and transmits the discharge battery data to the communications board 103. The communications board 103 transmits the discharge battery data, such as the SoC, to the local processor 102. In other examples, the communications board 103 reads the discharge battery data directly.

The local processor 102 compares the discharge battery data to at least one of the operational metrics. In some examples, the local processor 102 performs a calculation to compare the discharge battery data to the operational metrics. For example, the local processor 102 receives the SoC and determines a discharge rate based at least in part on the SoC.

In some examples, the local processor 102 determines a discharge battery metric based on the discharge battery data. The local processor 102 then compares the discharge battery metric to a corresponding operational metric. For example, the operational metric is a temperature of the battery 106 during flight. The local processor 102 determines a discharge temperature of the battery based on the battery discharge data and compares the discharge temperature to the operational temperature.

In one or more examples, the local processor 102 determines whether the discharge metric is within a threshold of the operational metric. If the discharge metric is not within a threshold of the operational metric, the local processor 102 adjusts, based on the comparison to the operational metric, the discharge metric. For example, the local processor 102 determines that the discharge rate of the battery 106 is outside of a threshold deviation from a discharge rate of the battery 106 during a flight. In response, the local processor 102 adjusts a discharge rate of the battery 106. The adjustment is during the discharge cycle.

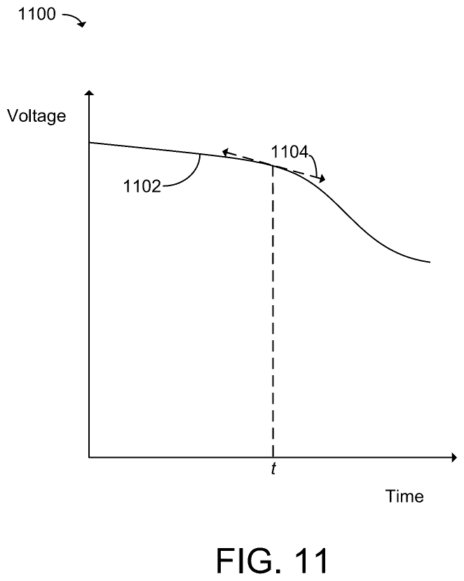

An “operational discharge rate” includes a rate at which the battery 106 has been discharged or is likely to be discharged during use in the device 424. In some examples, the operational discharge rates are non-linear. For example, FIG. 11 shows a graph 1100 of voltage of a battery 106 over time while the battery 106 is in use in the device 524. As shown in FIG. 10, the relationship is represented by the function 1102, which is a non-linear function. As such, the operational discharge rate changes over time. The local processor 102 receives the function 1102 from the device 424, determines discharge rates for each time t along the function 1102, and transmits those discharge rates to the communications board 103. At a time t of the discharge cycle, the communications board 103 instructs the charger board 105 to discharge the battery 106 at a rate equivalent to the operational discharge rate, defined by the slope of the tangential line 1104 at time t of the operational period.

In some examples, the discharge cycle involves discharging the battery 106 to a degree that is within an acceptable deviation of an operational discharge degree. For example, the local processor 102 receives data indicating that a 1000 mAh battery 106 has provided a current of 6000 mA over a period of one hour. The system 100 discharges the battery 106 at a rate sufficient to discharge a similar amount of current during a desired discharge cycle time. For example, the desired discharge cycle time is ten minutes. The system 100 discharges the battery 106 at a rate of 6 C. In other words, during the discharge cycle, a battery 106 of 1000 mAh provides 6000 mA of charge for ten minutes. In such embodiments, the charger board 105 discharges the battery 106 at a rate of 6 C, allowing the discharge cycle to be completed in approximately ten minutes.

In some examples, the processor 102 receives operational data for a future operational cycle. For example, a future operational cycle (e.g., flight) is expected to take place in a given location (e.g., Austin, Texas) on a particular date. The processor 102 receives and/or determines a forecast for that location and that date. For example, the processor 102 predicts a temperature of 90 degrees Fahrenheit on the expected day of operation. During the charge and/or discharge cycle, the communications board 103 adjusts the conditions of the battery 106 and/or of the charging/discharging environment. For example, the slot 104 is a closed chamber, and the chamber includes one or more temperature sensors in communication with the communications board 103. The communications board 103 reads a temperature of the slot 104 from the sensor. If the temperature is outside of an acceptable deviation from the predicted operational temperature, the communications board 103, to bring the temperature within the acceptable deviation, increases or decreases power supplied to cooling elements, such as fans or cooling hoses.

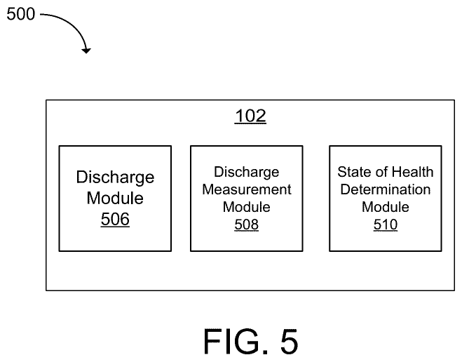

FIG. 5 is a schematic block diagram of an apparatus 500 for determining a SoH of a battery 106, according to various embodiments. The apparatus includes a local processor 102 as shown in FIGS. 1-5. The apparatus 500 includes a discharge module 506, a discharge measurement module 508, and a SoH determination module 510, which are described below. In some examples, all or a portion of the apparatus 500 is implemented with executable code stored on computer readable storage media. In other embodiments, at least a portion of the apparatus 500 is implemented using hardware circuits and/or a programmable hardware device. In some examples, the modules of the apparatus 500 are housed in at least one of: the local processor 102, the remote server 122, a client device, another processor, and/or any combination thereof.

The discharge module 506 is configured to initiate a discharge cycle while the battery 106 is received by the slot 104. In some examples, the discharge cycle directs current away from the battery 106. For example, the discharge module 506 instructs the communications board 103 to initiate the discharge cycle by communication with the charger board 105, communication with the switch 124, and/or activation of the power supply 107.

The discharge measurement module 508 is configured to measure discharge battery data of the discharge cycle from the battery 106. For example, the discharge measurement module 508 receives data read by the charger board 105 and/or the communications board 103 during the discharge cycle.

The SoH determination module 510 determines, based at least in part on the charge battery data and on the discharge battery data, an SoH of the battery 106. In some examples, the SoH determination module 510 is configured to predict a life expectancy of the battery 106 based at least in part on the SoH of the battery 106. In one or more examples, the life expectancy of the battery 106 includes a period of time and/or a quantity of typical operational cycles for the battery 106 during which the battery 106 is predicted to have sufficient SoH to be used in operation (e.g., to power the device 424). In some examples, the “sufficient SoH” is determined by the local processor 102 and/or remote server 122 based at least in part on the applications for which the battery 106 is used. In other examples, the “sufficient SoH” value is input by the user.

In some examples, the SoH determination module 510 is configured to predict a life expectancy of the battery 106 based at least in part on a machine learning algorithm result. In some examples, the inputs from the machine learning algorithm include life spans of other batteries 106, characteristics of other batteries 106, and/or operational conditions which the other batteries 106 are subjected to throughout their lifespan. The life span of a battery 106 includes, for example, a quantity of charge cycles, a quantity of operational cycles, a period of time, and/or any combination thereof. In some examples, the output of the machine learning algorithm is the total estimated lifespan of the battery 106, and the SoH determination module is configured to predict a remaining lifespan of the battery 106 by subtracting the battery 106's current age from the total estimated lifespan. In some examples, the current age has the same units as the total estimated lifespan (e.g., a quantity of charge cycles, a quantity of operational cycles, a period of time, and/or any combination thereof).

In some examples, the apparatus 500 further includes a charging module that actuates a circuit, such as the communications board 103 and/or the charger board 105, to direct power to each battery slot 104 of the plurality of battery slots 104 to charge a battery 106 received by the battery slot 104 in a charge cycle. In some examples, the apparatus 500 further includes a charging measurement module 504 configured to measure charge battery data of the charge cycle from the battery slot 104. For example, the charging measurement module reads data collected by the charger board 105 during the charge cycle.

Although not shown in FIG. 5, in some examples, the charging module is configured to determine charging conditions for a battery 106 based at least in part on learned outcomes and an output of a machine learning algorithm. The machine learning algorithm includes inputs such as charging conditions for that battery 106 and/or for a similar battery. Inputs include, for example, at least one of a charge rate and total SoC for a previous charge cycle for that battery 106. Outcomes include, for example, a SoH and/or SoH rate of degradation for that battery 106. The charging module uses the machine learning algorithm to determine and/or adjust at least one of total SoC and/or ideal charge rates for that battery 106 based on past outcomes.

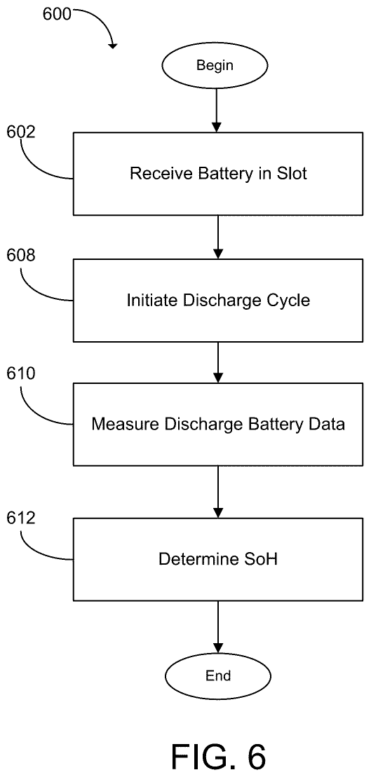

FIG. 6 is a schematic flow chart diagram illustrating one embodiment of a method 600 for determining a SoH of a battery 106. The method 600 begins and includes receiving 602 a battery 106 in a slot 104 such that the battery 106 is removable from the slot 104 to power a device that is separate from the slot 104. The method 600 includes initiating 608 a discharge cycle of the battery while the battery 106 is received by the slot 104. In some examples, initiating the discharge cycle involves directing current out of the battery 106. The method 600 includes measuring 610, during the discharge cycle, discharge battery data. The method 600 includes determining 612, based at least in part on the discharge battery data, a SoH of the battery 106.

In some examples, the method 600 is performed by any one of the discharge module 506, discharge measurement module 508, and/or SoH determination module 510.

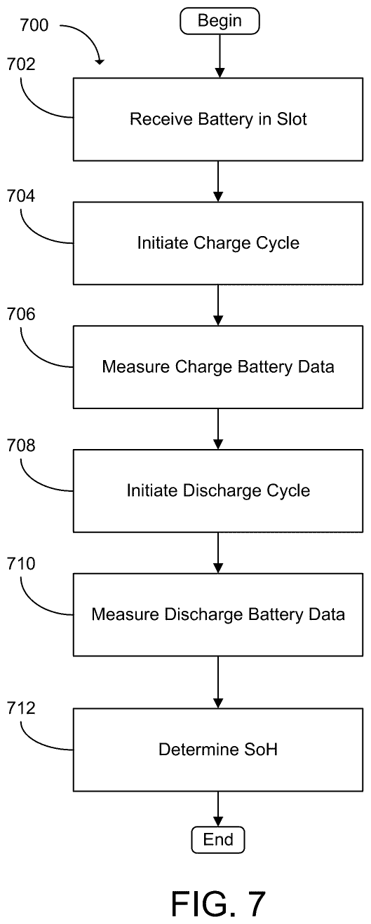

FIG. 7 is a schematic flow chart diagram illustrating one embodiment of a method 700 for charging a battery 106. In some examples, the method 700 is a continuation of the method 600 shown in FIG. 6. The method 700 includes receiving 702 the battery 106 within the slot 104. The method 700 includes initiating 704 a charge cycle to charge the battery 106 while the battery 106 is received by the slot 104. In some examples, initiating 704 the charge cycle includes directing power to the battery 106 to charge the battery 106. The method 700 includes measuring 706, during the charge cycle, charge battery data for the battery. The method 700 includes initiating 708 a discharge cycle and measuring 710 discharge battery data during the discharge cycle. The method 700 includes determining 712 a SoH of the battery 106. In some examples, the SoH is determined based at least in part on the charge battery data, the discharge battery data, and/or a combination thereof. In some examples, initiating 708 the discharge cycle is performed after the charge cycle is complete. In some examples, initiating 704 the charge cycle is performed after the discharge cycle is complete. In some examples, the charge battery data includes an input current for the battery 106 and an output current for the battery 106. In some examples, the discharge battery data includes at least one of: a current measurement from the battery 106, a temperature of the battery 106, a voltage measurement, or a combination thereof.

In some examples, the method 700 is performed by any one of the charging module, charging measurement module, discharge module 506, discharge measurement module 508, and/or SoH determination module 510.

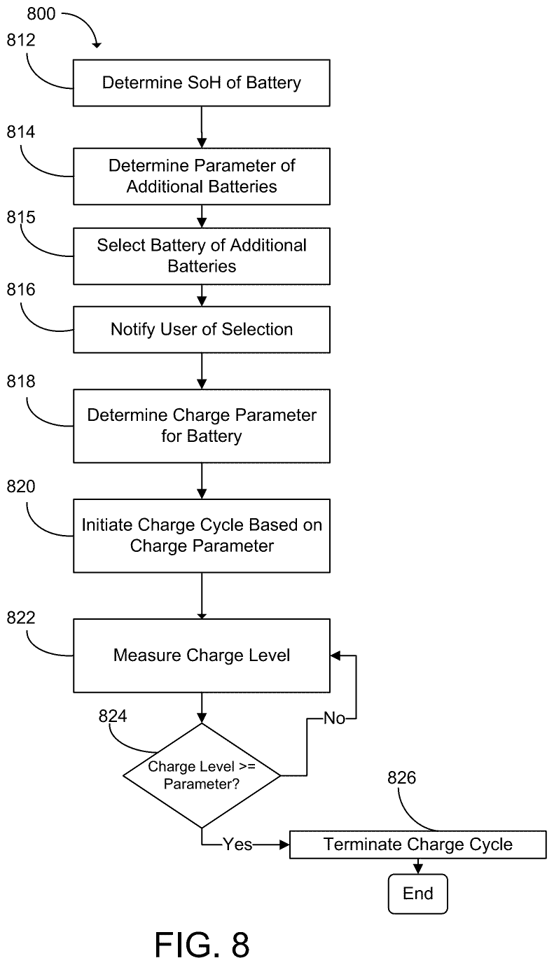

FIG. 8 is a schematic flow chart diagram illustrating one embodiment of a method 800 of charging a battery 106 based on a charging parameter. In some examples, the method 800 is a continuation of the method 600 of FIG. 6 and/or of the method 700 of FIG. 7. In some examples, the method 800 is performed by any one of the charging module, charging measurement module, discharge module 506, discharge measurement module 508, and/or SoH determination module 510.

The method 800 includes determining 812 a SoH of a battery 106 based at least in part on discharge battery data and/or charge battery data from a discharge cycle and/or a charge cycle. The method 800 includes determining 814 a parameter of a number of additional batteries 106. In some examples, the parameter includes at least one of: operational cycles, a battery age expressed as a time period, a predicted failure time, a predicted life expectancy, a charge rate, a discharge rate, and/or any combination thereof. In some examples, the number of additional batteries 106 includes a first number of additional batteries 106, and selecting 815 the battery 106 for pairing is further based at least in part on a SoH of the second number of additional batteries 106. In some examples, the second number of additional batteries 106 includes one or more batteries previously grouped with the battery 106 for powering the device 424.

In some examples, the method 800 includes selecting 815, based at least in part on the parameter and the state of health of the battery 106, a battery 106 of the number of additional batteries 106 to be paired with the battery 106. The method 800 includes notifying 816 a user of the selection.

In some examples, the method 800 includes determining 818, based at least in part on the SoH of the battery 106 and the parameter of the selected battery, a charging parameter for the battery. The method 800 includes initiating 820 a charge cycle to charge the battery 106 according to the charging parameter. In some examples, the charging parameter includes at least one of: a charging rate, a final SoC of the battery 106 at an end of the charge cycle, or a combination thereof. In some examples, the charging parameter includes a goal final charge level (e.g., final SoC) of the battery 106.

In some examples, the method 800 includes measuring 822, during the charge cycle, a charge level (e.g., SoC) of the battery 106. The method 800 includes comparing, during the charge cycle, the measured charging parameter (e.g., SoC) of the battery 106 to the measured charging parameter. The method 800 includes determining 824, based at least in part on the comparing and during the charge cycle, that the measured charge level (e.g., SoC) of the battery 106 is greater than or equal to the goal final charge level. If not, the method 800 includes continuing the charge cycle and measuring 822 the charge level. If the measured charge level is greater than or equal to the goal final charge level, the method 800 includes terminating 826 the charge cycle, and the method 800 ends.

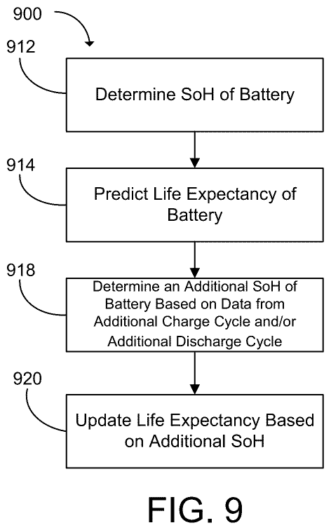

FIG. 9 illustrates one example of a method 900 for predicting a life expectancy of a battery 106. In some examples, the method 900 is a continuation of the methods 600, 700, and/or 800. In some examples, the method 900 includes determining 912 the SoH of the battery 106. The method 900 includes predicting 914 a life expectancy of the battery 106 based at least in part on the SoH. In some examples, predicting 914 the life expectancy is based at least in part on an output of a machine learning algorithm. An input of the machine learning algorithm includes at least one of: a characteristic of the battery 106, a battery 106 type, an application for the battery 106, an operational metric of the battery 106 while the battery powers the device 424, and/or a combination thereof.

In some examples, the method 900 includes measuring additional data for the battery 106 during at least one of a subsequent charge cycle and a subsequent discharge cycle. The method 900 includes determining 918 an updated SoH of the battery 106 based at least in part on that measured data. In some examples, the method 900 includes updating 920 the life expectancy predicted in step 914 based at least in part on the additional data and/or updated SoH.

FIG. 10 is a schematic flow chart of a method 1000 for discharging a battery 106 according to operational metrics. The method 1000 begins and includes receiving 1098 operational metrics (e.g., from the device 424). The operational metrics include data collected while the battery 106 powers the device 424. The method 1000 includes determining 1007, based at least in part on the number of operational metrics, a goal discharge parameter value for the battery 106. The method 1000 includes initiating 1008 a discharge cycle of a battery 106 to discharge the battery 106 according to the goal discharge parameter value.

The method 1000 includes determining 1010, during the discharge cycle, a measured discharge parameter value based at least in part on measured discharge battery data. The method 1000 includes comparing 1018, during the discharge cycle, the measured discharge parameter value to the goal discharge parameter value. The method 1000 includes determining 1020 whether the measured discharge parameter value is within an acceptable deviation of the goal discharge parameter value. If the discharge battery data is outside of the acceptable deviation, the method 1000 includes adjusting 1022, during the discharge cycle and in response to determining that the measured parameter value is not within the threshold deviation from the goal discharge parameter value, the discharging by adjusting a discharge parameter corresponding to the measured discharge parameter (e.g., by adjusting the ambient temperature, adjusting the discharge rate, etc.) and returns to step 1010. If the method 1000 determines that the discharge battery data is within an acceptable deviation of the operational metric, the method 1000 ends. In some examples, at that point, the discharge cycle continues without adjustments.

In some examples, the method 1000 is repeated at a specified frequency. In some examples, the method 1000 is performed by any one of the charging module, charging measurement module, discharge module 506, discharge measurement module 508, and/or SoH determination module 510.

FIG. 12A is an exterior view of an enclosure 1202 housing a charging apparatus 101. In some examples, the charging apparatus 101, the enclosure 1202, and the power source 108 are part of a system 1200. As shown in FIG. 12A, the enclosure 1202 is, in some examples, positioned on a vehicle and/or on a mobile trailer. In such examples, components such as the power supply 107, local processor 102, charging apparatus 101, charger boards 105, and communications boards 103, and power supplies 107 are portable. As shown in FIG. 12A, the power source 108 is positioned outside of the enclosure 1202, while the charging apparatus 101, charger boards 105, communications boards 103, and power supplies 107 are positioned within the enclosure 1202.

FIG. 12B is an internal view of the enclosure 1202. As shown in FIG. 12B, the enclosure 1202 includes a number of doors. The enclosure 1202 houses the slots 104, each of which include a door. The doors of the slots 104 are shown open in FIG. 12B. As shown in FIG. 12B, in some examples, the display 110 is located proximate to the slots 104.

As described herein, in some examples, the system 100 includes remote computing devices, such as mobile computing devices. The remote computing devices are client devices connected to the network 120. In some examples, the remote computing devices are located outside of the enclosure 1202. The system 100 includes a mobile application accessed by the client device(s) through the network 120. In some examples, the system 100 also includes a web application to be accessed by the client device(s) through the network 120.

As shown in FIG. 12B, the slots 104 are stacked vertically. Each slot 104 includes a chamber with a door that opens and closes to receive the battery 106. In some examples, the slots 104 are made of a conductive material, such as metal. In some examples, the slots 104 are made of an insulating material.

Although FIG. 1 illustrates a single battery 106 within each slot 104, examples of the present disclosure are not so limited. In some examples, the slot 104 holds multiple batteries 106 simultaneously. For example, each slot 104 has a total volume of greater than 0.5 and less than 3 cubic feet. For example, the slot 104 has a total volume of approximately one cubic foot. In some examples, the slots 104 share walls. The slots 104 include small openings through which wires, such as communication cables and cables connecting each charging board 105 to the power supply 107, are fed.

Although not shown in FIGS. 1-12B, in some examples, the slots 104 include cooling elements. For example, each slot 104 includes at least one of a fan or a hose. In some examples, the slot 104 includes an exhaust hose configured to exhaust air from a load used for the discharge cycle. In some examples, each slot 104 includes a number of ports. For example, the number of ports includes a cold air input port, a cold air output port, a hot air input port, and a hot air output port. Each port is connected to a valve that opens and closes the port. For example, each port is connected to a solenoid with a valve. The solenoid is in communication with the communications board 103 and is configured to be closed and/or opened based on instructions received from the communications board 103. For example, the communications board 103 and/or the processor 102 determines that a slot 104 needs to be cooled based on temperature sensors on the battery 106. In response, the cold air input solenoid opens its valve. In some examples, the processor 102 determines that hot air should flow into the slot 104 to simulate operational conditions during a discharge cycle. The communications board 103 transmits a signal to the hot air input solenoid to open its valve and/or a signal to the cold air input solenoid to close its valve.

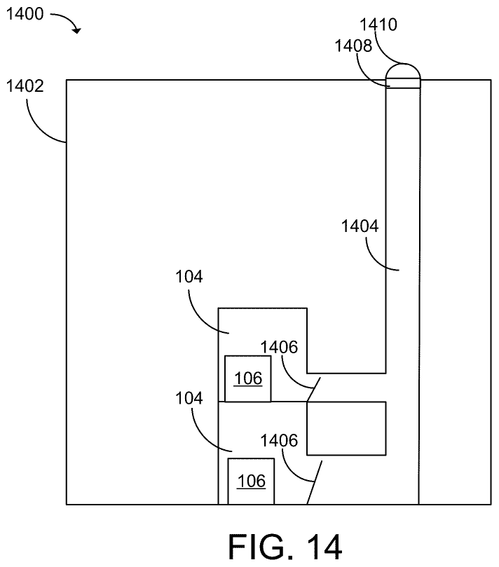

FIG. 14 is a schematic diagram of a system 1400, according to one or more examples of the present disclosure. In some examples, the system 1400 is an example of the system 100. In some examples, the system 1400 includes an enclosure 1402 that houses one or more slots 104. In some examples, the slots 104 receive the batteries 106 for charging and/or discharging, which can lead to overheating and/or combustion. In some examples, the slots 104 each include a trap door 1406 that opens in response to heighted temperature and/or pressure to allow exhaust escape from the slot 104.

In some examples, the enclosure 1402 includes a duct 1404 into which the exhaust can be directed from the slot 104. In some examples, the system 100 includes a carbon filter 1408 located within the duct 1404 and/or proximate to the duct 1404. In various examples, the exhaust travels from the slot 104, into the duct 1404, through the carbon filter 1408, and out of the enclosure 1402. In some examples, trap doors 1406 of multiple slots 104 each connect to a common duct 1404. For example, a column of slots 104 are all connected to a common duct 1404 that directs exhaust through an opening in a ceiling of the enclosure 1402. In various examples, a carbon filter 1408 and/or other filter configured to filter out harmful gases is positioned within and/or proximate to the opening. Gases that pass through the carbon filter 1408 can then exit the enclosure 1402. In some examples, a balloon 1410 or other expandable material is attached to the enclosure 1402, positioned outside of the enclosure 1402, and is configured to at least partially contain gases that escape from the enclosure 1402.

In some examples, the system 1400 includes a blast chamber that is separate from the slots 104. In various examples, the blast chamber is a separate chamber located outside of the enclosure 1402, such as proximate to the power source 108. In one or more examples, the duct 1404 and/or hose connects one or more slots 104 to the blast chamber to direct exhaust from the slots 104 to the blast chamber. In various examples, the blast chamber includes a top side with an opening. In some examples, a carbon filter and/or other filter configured to filter out harmful gases is positioned within and/or proximate to the opening. Gases that pass through the carbon filter can then exit the blast chamber. In some examples, a balloon or other expandable material is attached to a top side of the blast chamber and is configured to at least partially contain gases that escape from the blast chamber 104.

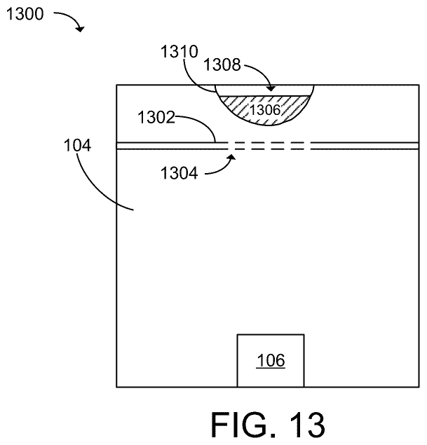

FIG. 13 is a schematic diagram of a system 1300, according to one or more examples of the present disclosure. In some examples, the system 1300 is an example of the system 100. In one or more examples, the system 1300 includes mechanisms for suppressing fire using a fluid fire suppressant 1306. For example, the slot 104 can house a bladder 1310 attached to a ceiling of the slot 104, creating a reservoir 1308 between the bladder 1310 and the ceiling. In some examples, the reservoir 1308 is filled with the fire suppressant 1306. In some examples, the bladder 1310 is made of a material that melts, deforms, and/or detaches from the ceiling when exposed to heat. When the bladder 1310 melts away, the fire suppressant 1306 pours through a perforated sheet 1302 and onto the battery 106 within the slot 104. In some examples, the perforated sheet 1302 is designed to direct the suppressant to a particular area of the slot 104. For example, the perforated sheet includes perforations 1304 concentrated in an area of the perforated sheet that align with an area of the slot 104 in which the battery 106 is to be located. In some examples, the perforated sheet 1302 is positioned between the bladder or other liquid fire suppressant source and the battery 106.

In some examples, the suppressant 1306 includes at least one of: water, a foaming agent, carbon dioxide, heptafluoropropane, 2-methyl-3-pentanone, nitrogen, potassium salts (e.g., potassium ascetate or potassium citrate), argon, bromochlorodifluoromethane, bromotrifluoromethane, and/or any combination thereof.

In other examples, the suppressant 1306 is distributed via a smart nozzle that communicates with a temperature sensor within the slot 104. In another example, the nozzle is not a smart nozzle but is activated by a mechanical spring to expel the suppressant 1306.

In some examples, the slots 104 are made of and/or coated with insulating materials, flame retardants, and/or fire-proof materials.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving a battery in a slot, wherein the battery is removable from the slot to power a device separate from the slot;
initiating a discharge cycle of the battery while the battery is received by the slot;
measuring, during the discharge cycle, discharge battery data for the battery; and
determining, based at least in part on the discharge battery data, a state of health of the battery.

2. The method of claim 1, wherein:
the method further comprises:
initiating a charge cycle to charge the battery while the battery is received by the slot; and
measuring, during the charge cycle, charge battery data for the battery; and
determining the state of health of the battery is further based at least in part on the charge battery data.

3. The method of claim 2, wherein:
the charge battery data comprises an input current for the battery and an output current for the battery; and
the discharge battery data comprises at least one of: a current measurement from the battery, a temperature of the battery, a voltage measurement, or a combination thereof.

4. The method of claim 1, further comprising:
determining a parameter of a number of additional batteries;
selecting, based at least in part on the parameter and the state of health of the battery, a battery of the number of additional batteries to be paired with the battery; and
notifying a user of the selection.

5. The method of claim 4, wherein the parameter comprises at least one of: a state of health, a battery age expressed as a quantity of discharge and/or operational cycles, a battery age expressed as a time period, a predicted failure time, a predicted life expectancy, a charge rate, a discharge rate, and/or any combination thereof.

6. The method of claim 4, wherein:
the number of additional batteries comprises a first number of additional batteries;
the selecting is further based at least in part on a state of health of a second number of additional batteries; and
the second number of additional batteries comprises one or more batteries previously grouped with the battery for powering the device.

7. The method of claim 4, further comprising:
determining, based at least in part on the state of health of the battery and the parameter of the selected battery, a charging parameter for the battery; and
initiating a charge cycle to charge the battery according to the charging parameter.

8. The method of claim 7, wherein the charging parameter comprises at least one of: a charging rate, a final charge level of the battery at an end of the charge cycle, or a combination thereof.

9. The method of claim 7, wherein the charging parameter comprises a goal final charge level of the battery, and the method further comprises:
measuring, during the charge cycle, a charge level of the battery;
comparing, during the charge cycle, the charge level of the battery to the goal final charge level;
determining, based at least in part on the comparing and during the charge cycle, that the charge level of the battery is greater than or equal to the goal final charge level; and
terminating the charge cycle in response to the determining.

10. The method of claim 1, further comprising predicting a life expectancy of the battery based at least in part on the state of health.

11. The method of claim 10, wherein the discharge cycle comprises a first discharge cycle and the method further comprises:
measuring additional data for the battery during a second discharge cycle; and
updating the predicted life expectancy of the battery based at least in part on the additional data.

12. The method of claim 10, wherein the life expectancy of the battery is based at least in part on an output of a machine learning algorithm, wherein an input of the machine learning algorithm comprises at least one of: a characteristic of the battery, a battery type, an application for the battery, an operational metric of the battery while the battery powers the device, and/or a combination thereof.

13. The method of claim 1, further comprising:
receiving a number of operational metrics, the operational metrics comprising data collected while the battery powers the device; and
determining, based at least in part on the number of operational metrics, a goal discharge parameter value for the battery, wherein discharging the battery in the discharge cycle comprises discharging the battery according to the goal discharge parameter value.

14. The method of claim 13, wherein the number of operational metrics comprise an operational battery discharge rate, and discharging the battery according to the goal discharge parameter value comprises discharging the battery at a rate that is within a threshold of the operational battery discharge rate.

15. The method of claim 13, further comprising:
determining, during the discharge cycle, a discharge parameter value based at least in part on the discharge battery data;
comparing, during the discharge cycle, the discharge parameter value to the goal discharge parameter value;
determining, based at least in part on the comparing, whether the discharge parameter value is within a threshold deviation from the goal discharge parameter value; and
adjusting, during the discharge cycle and in response to determining that the discharge parameter value is not within the threshold deviation from the goal discharge parameter value, a discharge parameter corresponding to the discharge parameter value.

16. The method of claim 1, further comprising directing, during the discharge cycle, current from the battery into a load, wherein the load comprises at least one of:
an additional battery charged by the directed current;
an uninsulated conductor connected to an exhaust element;
a device powered by the directed current; or
a combination thereof.

17. The method of claim 1, wherein measuring the discharge battery data comprises receiving the discharge battery data from a battery management system of the battery.

18. A system, comprising:
a slot configured to receive a battery, wherein the battery is removable from the slot to power a device, the device being separate from the slot;
a memory; and
at least one processor coupled to the memory and configured to:
initiate a discharge cycle to discharge the battery while the battery is received by the slot;
measure, during the discharge cycle, discharge battery data for the battery; and
determine, based at least in part on the discharge battery data, a state of health of the battery.

19. The system of claim 18, further comprising a plurality of batteries and a plurality of slots, wherein the slot comprises a slot of the plurality of slots and the battery comprises a battery of the plurality of batteries.

20. An apparatus, comprising:
a discharge module configured to initiate a discharge cycle while a battery is received by a slot from which the battery is removable to power a device separate from the slot;
a discharge measurement module configured to measure, during the discharge cycle, discharge battery data for the battery; and
a state of health module configured to determine, based at least in part on the discharge battery data, a state of health of the battery,
wherein at least a portion of said modules comprise one or more of hardware circuits, programmable hardware circuits and executable code, the executable code stored on one or more computer readable storage media.
